(19) United States
(12) Patent Application Publication
(10) Pub. No.: US 2011/0259212 A1
(43) Pub. Date: Oct. 27, 2011

(54) DEVICE FOR COMPRESSING RECYCLABLE MATERIALS

(76) Inventors: Malcolm N. Jubinville, Calgary (CA); Norm Jubinville, Calgary (CA)

(21) Appl. No.: 12/764,223

(22) Filed: Apr. 21, 2010

(51) Int. Cl. B30B 1/00

(52) U.S. Cl. 100/214

(57) ABSTRACT

A two-stroke hand operated container crusher designed for crushing various recycling materials that have deposit payments associated with them. It is a rectangular shaped box comprised of four solid sides, a base, and top, which creates a hollow chamber. This chamber houses the crusher mechanics and the containers to be crushed. A crushing head is operated manually by a handle, which forces the piston down. This downward force crushes the container housed at the base of the unit. The crushing force is amplified by the use of a fulcrum, hinge, and a pivot system. A guide groove is provided in which a pawl slides to lock the head at a first stage position to permit the lever to be retracted and re-applied to effect a second stroke of a two-stroke operating system results in dimension savings while still maintaining a required distance of crushing.

This invention relates generally to a device for compressing recyclable materials. In particular, it relates to devices that crush objects from their original size for the purpose of improved storage capacity. This invention provides an improved means to manually compress beverage cans and expands to include the ability to crush all recyclable containers.

### BACKGROUND OF THE INVENTION

Previous patented arrangements have used either a single pivot point or have incorporated a fulcrum via hinges to achieve the crushing motion, and can be either hand or foot operated.

However in general these have failed to solve the problem of being able to crush multiple types of recyclable containers. Many designs of crushers designed to crush beverage cans have been provided and have obtained some success in the market. However they are designed to crush only small containers, such as aluminum cans, which comprise approximately 20% of the recyclable containers being sold to consumers, thus not covering all recyclable containers, indicating a need for improvement.

### SUMMARY OF THE INVENTION

It is one object of the present invention to provide a device for compressing a variety of recyclable containers of varying shapes, sizes and materials.

The arrangement described hereinafter will solve these problems while providing the result with only moderate force and in quick succession.

According to a first aspect of the invention there is provided a crusher comprising:

a housing defining a bore into which one of more items to be crushed can be placed

the housing having an end plate defining an anvil against which the items are crushed;

a crusher head slidable within the bore in a crushing movement from a retracted position spaced from the anvil to a crushing position closely adjacent the anvil for crushing the items;

the housing defining an opening into the bore for insertion of the items to be crushed into the bore;

a manually operable lever having a manually graspable end portion movable in a crushing stroke relative to the housing for applying a force acting to move the crusher head along the bore;

the lever, the housing and the crusher head being arranged such that a first movement of the lever through the crushing stroke acts to move the crusher head through a first part of the crushing movement from the retracted position to an interim position spaced from the crushing position and such that a further movement of the lever through the crushing stroke acts to move the crusher head through a second part of the crushing movement to the crushing position.

Preferably the housing and the crusher head are arranged such that the second stroke moves the crusher head from the interim position to the crushing position so that only two strokes of the lever are required. However more than two strokes can be used by providing two or more interim positions.

Preferably the lever is pivoted at a fixed position on the housing and the lever is movable relative to the crusher head between a first position in which movement of the lever through the crushing stroke acts to move the crusher head through the first part of the crushing movement and a further position in which movement of the lever through the crushing stroke acts to move the crusher head through the further part of the crushing movement. In this way the lever uses the housing as a fulcrum and acts to push the crusher head as it is pivoted by the user. In this case the lever is moved to a different position relative to the crusher head for the two separate strokes.

Preferably in this arrangement, there is provided a link connected from the lever to the crusher head such that pivotal movement of the lever on the housing acts to apply moving force to the crusher head through the link.

Preferably in this arrangement, the link is slidable longitudinally along the crusher head to move the lever between the first and further positions.

Preferably in this arrangement, the crusher head includes a first abutment surface against which the link abuts in the first position and a further abutment surface against which the link abuts in the further position.

Preferably in this arrangement, the link is movable transversely of the crusher head from the first abutment surface to the further abutment surface.

Preferably in this arrangement, the link includes an abutment member which engages an element on the housing arranged such that retraction of the link by the lever to a commencement end of the crushing stroke causes the link to be returned to the first position.

Preferably there is provided a spring acting to bias the crusher head to the retracted position

Preferably the lever, the housing and the crusher head are arranged such that a single reverse movement of the lever back through the crushing stroke to a commencement position acts to move the crusher head directly back to the retracted position.

Preferably there is provided a latch system arranged to locate the crusher head in the interim position and to prevent movement of the crusher head to the retracted position as the lever is moved back through the crushing stroke to a commencement position for the further stroke.

Preferably in this arrangement, the latch system includes a first portion mounted on the crusher head and a second portion mounted in the housing so as to locate the crusher head in the interim position relative to the housing.

Preferably in this arrangement, the first portion on the crusher head comprises a pivotal pawl and the second portion on the housing comprises an abutment guide arranged to move the pawl into a latching position in the interim position and to release the pawl from the latching position as the crusher head is returned to the retracted position.

Preferably there is provided a spring pulling the lever into the commencement position.

Preferably there is provided a locator ring on a crushing face of either the crusher head or the anvil for engaging around the mouth of a plastic bottle to locate the bottle between the crusher head and the anvil to avoid toppling during crushing.

Preferably in this arrangement, the other of the crusher head and the anvil includes an array of protuberances on the crushing face thereof.

Preferably the housing includes a front face with a slot in the front face through which the lever projects for movement longitudinally of the front face and wherein the opening is provided in the front face.

Preferably the end plate defining the anvil is mounted in a slot in the housing allowing the end plate to be removable by sliding across the bore to allow crushed materials to escape from the end of the bore.

The device is thus manually operated to compress varying sizes of recyclable materials utilizing components of specific design and precise placement. The motion of the handle causes the piston to travel downward along the cavity created by the front, back, and side walls. These walls provide a guide for the piston to travel through securely and in correct alignment.

### BRIEF DESCRIPTION OF THE DRAWINGS

One embodiment of the invention will now be described in conjunction with the accompanying drawings in which:

FIG. 1 is an isometric view of the compression device fully assembled with the handle in a perpendicular position to the main body.

FIG. 2 is an isometric view of the compression device of FIG. 1 with partial disassembly of the top, front, and right panels exploded to reveal the internal components of the device.

FIG. 3 is an isometric view of the compression device of FIG. 1 showing all components as fully disassembled in an exploded view.

FIG. 4 is a bottom plan view of the crusher head of FIG. 1.

FIG. 5 is a cross sectional view of the crusher head of FIG. 1 showing the two positions of the link with the reference numerals in the second position being shown in brackets.

FIG. 6 is a cross sectional elevational view of the crusher head of FIG. 1 showing the operation of the latching pawl.

FIGS. 7A to 7F show the cross-section of FIG. 5 as a series of separate sequential positions of the operation of the device.

### DETAILED DESCRIPTION

The description which follows and the embodiments described therein are provided by way of illustration of an example or examples of particular embodiments of the principles of the present disclosure. These examples are provided for the purposes of explanation and not limitation of those principles and of the disclosure. In the description which follows, like parts are marked throughout the specification and the drawings with the same respective reference numerals.

In the figures is shown a crusher assembly arranged for crushing various objects including beverage cans, beverage bottles and larger containers. The device is particularly designed to accommodate containers up to 4 liters in size so that substantially all beverage containers which vary from the smaller cans through 1 liter, 2 liter and 4 liter containers can all be received within the same device for crushing.

The intention is that in all cases the beverage containers of the type which carry a recycling deposit can be compressed so as to reduce the volume of stored materials for recycling down to approximately 10 to 20% of the original volume. This compression allows the recycling materials to be stored in a smaller volume allowing the householder to collect the recycling materials, compress them to a smaller volume and store them for subsequent return to collect the deposits where such deposits are available.

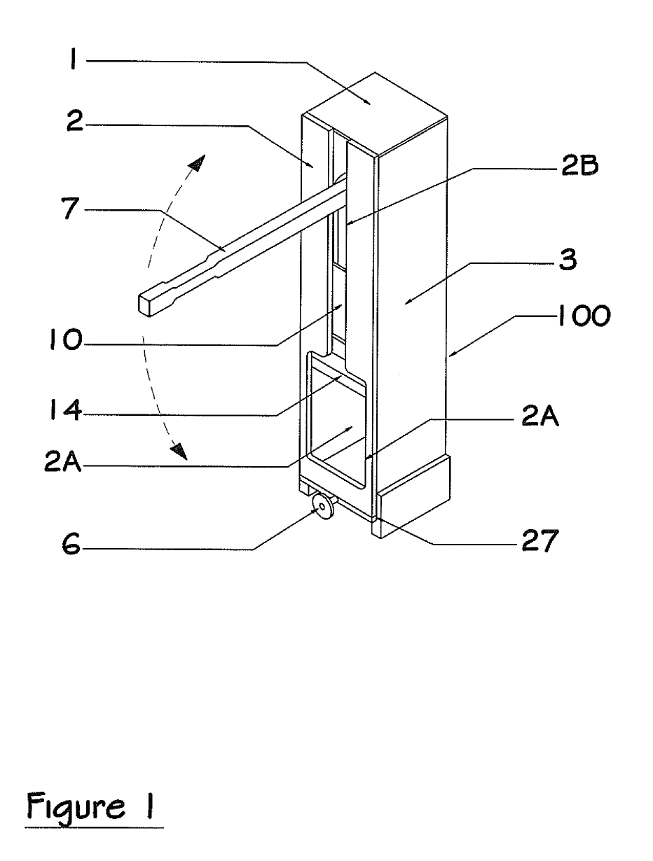

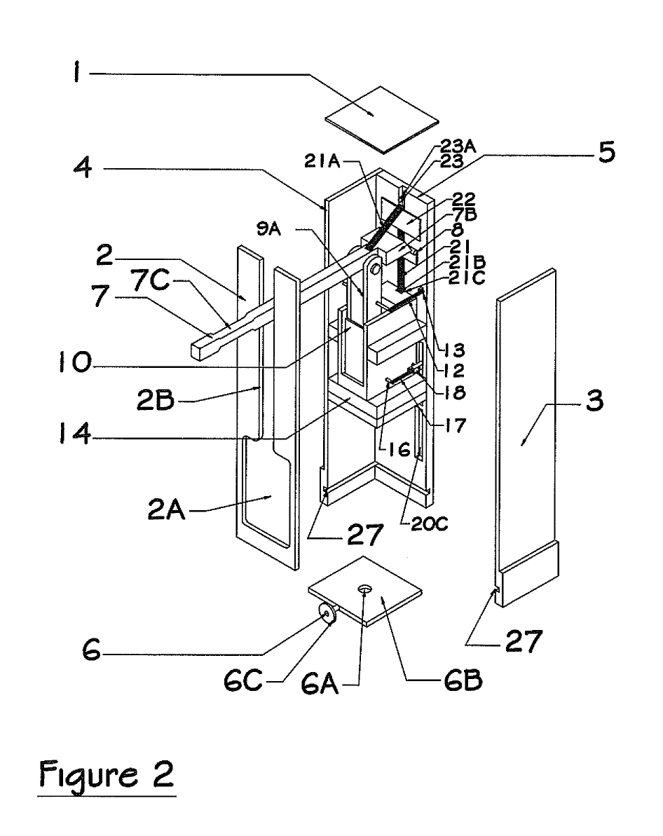

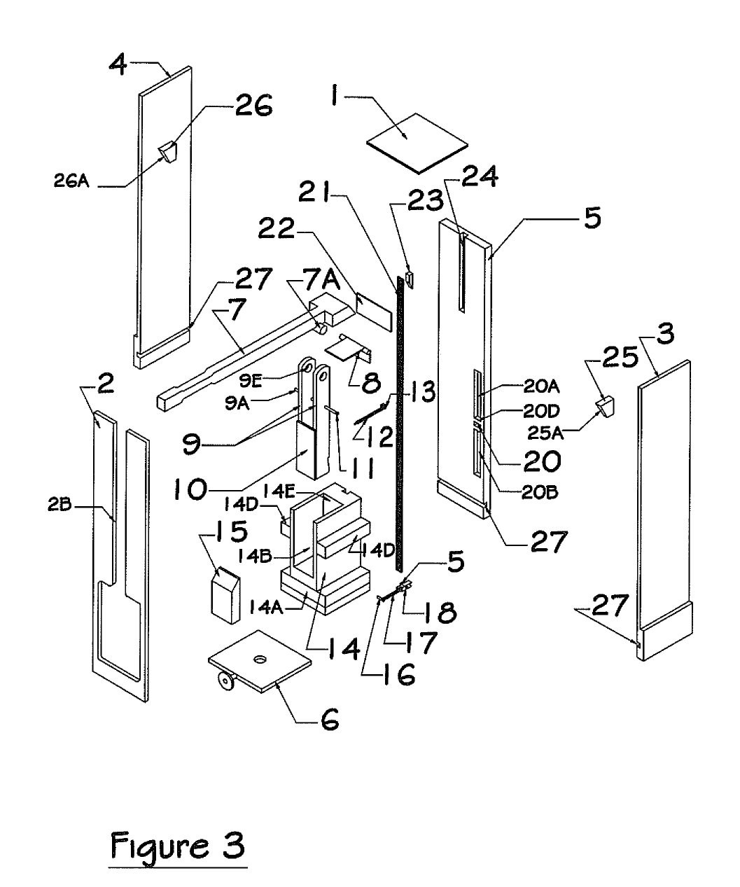

The assembly shown in assembled condition in FIG. 1 comprises a housing generally indicated at 100 which includes a top wall 1, a front wall 2, two side walls 3 and 4 and a rear wall 5. These are connected together by suitable coupling components so as to form a generally rectangular housing which is elongate in the vertical or longitudinal direction for movement of the crushing action longitudinally of the housing.

In the arrangement shown it will be appreciated that the housing is vertical but it will also be possible that the housing can be arranged in other orientations.

The side walls 3 and 4 each include a groove 27 adjacent a bottom edge with the groove also extending into the rear wall 5. The front wall 2 has a bottom edge spaced upwardly from the bottom edge of the remaining walls so that the front edge of the groove 27 is visible at the front of the housing. A bottom wall member generally indicated at 6 can be inserted into the groove by sliding underneath the bottom edge of the front wall 2. The end plate includes a rectangular plate member 6B attached to a handle 6C at the forward edge so that the flat plate 6B can slide into the groove 27 to be received and held within the bottom of the housing. The handle can be pulled to remove the plate 6B to allow materials in the housing to fall downwardly through the open bottom of the housing when the bottom plate 6B is removed. At the center of the bottom plate 6B is provided a raised ring 6A which stands slightly upwardly from the otherwise flat surface of the plate 6B to provide a receptacle for the mouth of a container to be crushed onto the end plate 6B.

The front wall 2 includes a rectangular opening 2A with a bottom edge of the rectangular opening close to the bottom edge of the front wall but spaced upwardly therefrom so that the opening 2A is located just above the bottom plate 6B. The opening 2A has side edges close to the side edges of the front wall so that the opening has a width slightly less than the width of the housing allowing materials to be crushed to be inserted into the housing. The height of the opening 2A is sufficient to receive the containers to be crushed including the 2 liter and 4 liter containers to be inserted into the housing onto the top of the plate 6B. At the top of the opening 2A is provided a groove or channel 2B which extends upwardly from the opening 2A through to a top edge of the front wall 2. The top of the groove 2B is therefore closed as shown in FIG. 1 by the top plate 1. The groove 2B provides a channel for movement of a handle 7 longitudinally of the groove and therefore longitudinally of the housing so as to apply a crushing action on a crusher head 14.

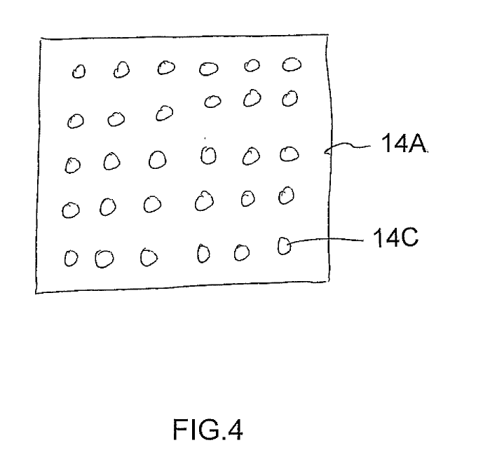

The crusher head 14 comprises a crusher plate 4A at the bottom which has a rectangular end face substantially equal in dimensions to the interior of the housing so that the end crusher plate 14A can slide longitudinally of the housing. The end face of the crusher plate 14A is shown in FIG. 4 and includes a series of protuberances 14C arranged in rows and columns so that the protuberances provide a roughened surface to hold and locate the end of the element to be crushed which is opposite to the end abutting the plate 6B.

The crusher head 14 further includes side guide members 14D which provide side surfaces equal in dimension to the sides of the crusher plate so that these side surfaces can also slide against the inside surfaces of the side walls 3 and 4 to guide the movement of the crusher head.

The crusher head further includes a slot 14B which extends from a front face of the crusher head through to a rear wall 14E defining a rear surface of the crusher head. The slot 14B is narrower than the width of the crusher head and provides a receptacle for receiving a link 9A which extends from the lever 7 to the crusher head.

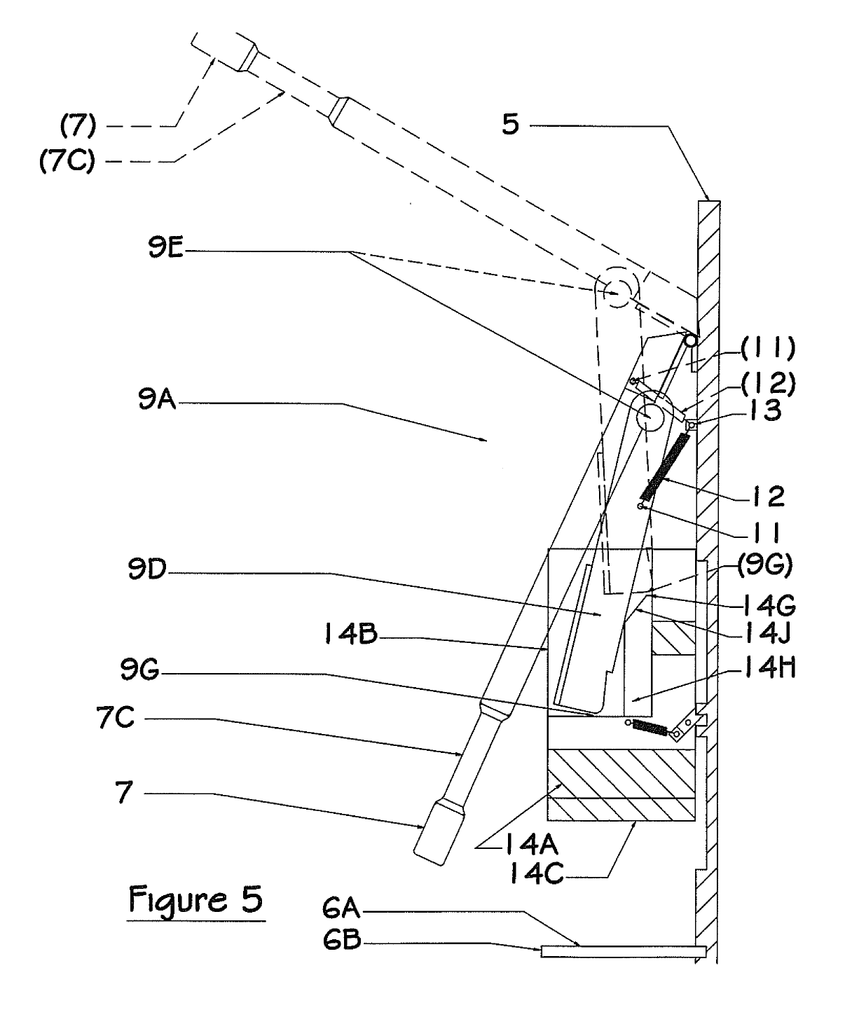

The link 9A comprises a pair of side walls 9 which are connected by a front plate 10. The width of the link is substantially equal to the width of the slot 14B so that the link can sit within the slot. The depth of the link 9A in the forward to rearward direction is however less than the length of the slot 14B so that the link can move in a direction front to rear within the slot. The link can therefore take up two separate positions within the slot 14B that is a rear position 9C and a front position 9D as shown in FIG. 5.

The link 9A includes at its upper end in the side walls 9 a transverse hole 9E which extends in a direction side to side of the housing for receiving a drive pin 7A of the lever 7. Thus the link has its upper end attached too the lever 7 so that movement of the lever 7 in an upward and downward direction longitudinally of the slot 2B causes the link to move upwardly and downwardly relative to the crusher head 14.

The lever 7 carries at its rear end a hinge coupling 8 which attaches the rear end 7B of the lever to the rear wall 5 at a position adjacent to but spaced downwardly from the top cover plate 1. Thus the rear end of the lever is mounted at a fixed height in the housing but can pivot about the hinge 8 so as to cause the hinge 8 fixed on the housing to act as a fulcrum. In this way manual grasping of a handle end 7C of the lever 7 causing movement of the lever upwardly and downwardly within the slot 2B causes the link 9A to move upwardly and downwardly relative to the housing.

The crusher head 14 as best shown in FIG. 5 includes a first abutment surface 14F at a position closely adjacent the bottom of the crusher head and a second abutment surface 14G at a position partway down the height of the crusher head. The bottom abutment surface 14F co-operates with the link 9A when in its forward position 9D. The abutment surface 14G co-operates with the link 9A when in its rear position 9C.

In an initial condition of the crusher assembly, the link 9A is in the forward position 9D abutting the first abutment surface 14F. In this position the lever 7 is pulled to an uppermost position inclined upwardly toward the top of the slot 2B by a spring cord 21. The spring cord 21 includes a first portion 21A which extends from the top of the lever upwardly and rearwardly to a location 23A at a holder 23 attaching the spring cord 21 to the rear wall 5. The holder 23 comprises a wedge which is inserted into a groove 24 in the rear wall 5 which is covered by a plate 22. Thus the wedge engages into the confined area between the plate 22 and the groove 24 and pinches the cord 21.

The spring cord 21 also includes a portion 21B extending downwardly behind the rear end 7B of the lever along the rear wall 5 to engage into a slot 21C in the crusher head. The spring cord 21 thus acts in the initial condition of the components to pull the lever upwardly to the uppermost position of the lever and to pull the crusher head upwardly to the uppermost position of the crusher head. In this position the front face of the crusher plate 14A is located at or slightly above the top of the opening 2A allowing the elements to be crushed to be inserted through the opening into the area between the crusher plate and the bottom plate 6B acting as an anvil.

In a first stroke of the lever 7 pivoted downwardly by manual grasping of the handle 7C, the link 9A in its initial position 9D is forced downwardly thus pushing the crusher head downwardly into a first interim position located by the bottom of the stroke of the lever 7. This interim position is spaced upwardly from a bottom crushing position and is located at a groove 20 in the rear wall 5. The crusher head is latched into this position at the groove 20 by a latching system generally indicated at 16A. The latching system in general acts so that it allows the crusher head to move downwardly into the interim position at the groove 20 and then to latch the crusher head against upward movement. The crusher head is pulled upwardly by the lower portion of the spring cord 21 thus holding the crusher head against the latch assembly 16A. While the crusher head is held in this position, the lever 7 can be moved upwardly to the initial upper position for the commencement of a further crushing stroke. During this movement the crusher head remains in the interim position. During this movement the lever 7 and the link 9A are pulled upwardly. As the link 9A moves upwardly, it moves away from the abutment surface 14F. A spring 12 is fastened to the rear wall 5 by a fastener 13. The forward end of the spring 12 is fastened to a transverse pin 11 across the sides walls 9 parallel to the drive pin in the holes 9E. The spring 12 applies tension therefore to the pin 11 and to the link 9A acting to pull the link 9A rearwardly to move the link 9A from the position 9D into the position 9C. Thus as the lower end of the link moves upwardly carried by the lever 7, the lower end of the link indicated at 9G passes along a face 14H within the slot 14B and along an inclined surface 14J up to the abutment surface 14G. This position is shown in FIG. 5 in dash line where the lever has been pulled upwardly and the link thus moves rearwardly so that its lower end 9G butts the surface 14G.

In this raised position of the lever 7, the lever is ready for a second crushing stroke in the lever is again moved downwardly along the slot 2B, but in this case the lever pushes against the surface 14G which is raised upwardly within the slot of the crusher head so that the lever and the link 9A act to drive the crusher head downwardly into the crushing position shown in FIG. 5. During this movement the latching assembly 16A allows the crusher head to move downwardly from its latched position at the groove 20.

Thus in operation the crusher head is moved in two strokes of the lever from its initial raised position held by the spring cord 21 downwardly into firstly the interim position at the groove 20 and then in the second stroke downwardly from the interim position to the crushing position where the crusher head has its end face closely adjacent the anvil defined by the plate 6B.

The latching assembly 16A comprises a pin 16 which is fastened to the side of the crusher head in the area between the bottom crusher plate and the side members 14D. The pin 16 carries a spring 17 acting to pull on a pawl member 18. The spring is attached to a hole 18A in the pawl member. The pawl member is pivotal on a pin 18B carried on the side of the crusher head. The pawl member 18 includes a pawl face 18C shaped to engage onto a rectangular abutment face 20D at the groove 20.

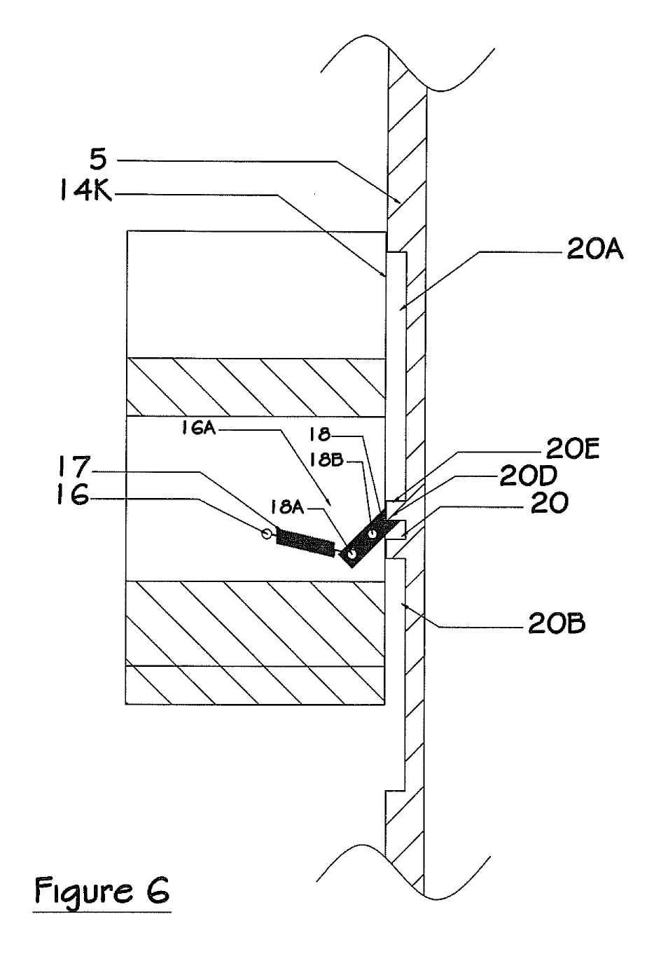

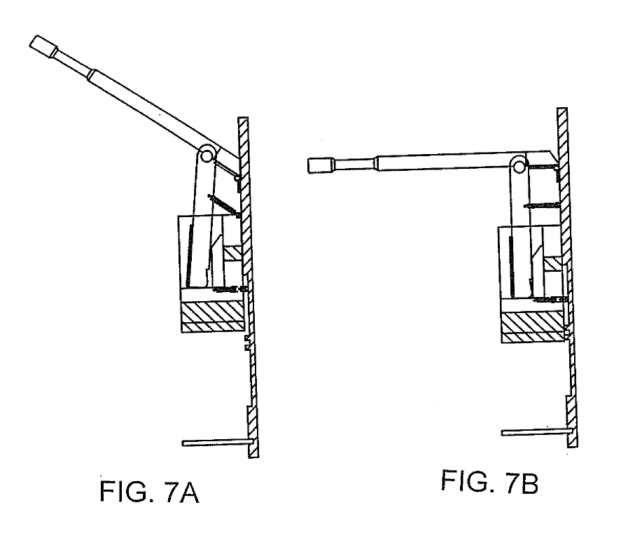

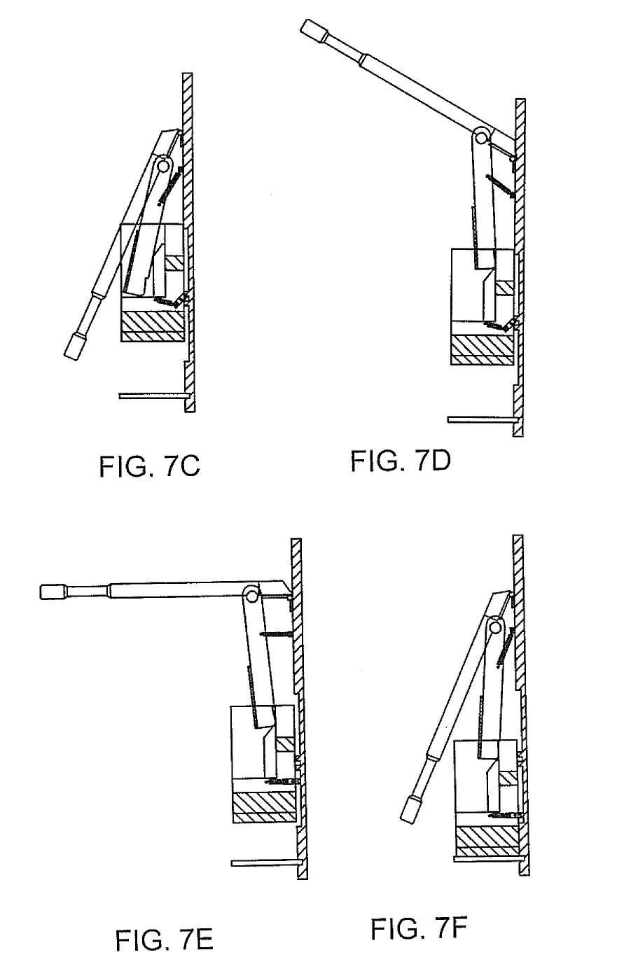

In an initial position of the pawl, the pawl extends along a common line with the spring so as to extend rearwardly from the pin 18B into a first groove portion 20A. Thus the pawl extends outwardly beyond the rear face 14K of the abutment head into the groove 20A in the rear wall 5. At the bottom of the groove portion 20A is provided an abutment face 20E which acts to pivot the pawl member 18 around the pin 18B to take up the position shown in FIG. 6. In this position the pawl moves downwardly beyond the bottom end of the groove 20A into the groove 20 where it engages the shoulder 20D to prevent upward movement of the crusher head from the groove 20. A further groove portion 20B is provided below the groove 20 so that when the crusher moves downwardly in the second stroke beyond the abutment 20D, the pawl again takes up the horizontal position aligned with the spring 17 while it is within the groove 20B. Thus when the crusher head moves upwardly at the end of the crusher stroke to turn to the initial position, the pawl is pivoted so that's its end face 180 faces downwardly allowing the pole to move past the shoulders at the grooves 20, 20A and 20B back up to the initial position at the top of the groove 20A.

After the two stroke crushing action is complete, upward movement of the handle 7 is caused by the action of the spring cord 21 pulling on the handle and pulling on the crusher head. Thus the components move automatically back to the initial position for the first crushing stroke. During this movement the pin 11 projecting through the plates 9 of the link 9A engage a pair of abutments 25 and 26 mounted on the inside surface of the side walls 3 and 4 respectively. These abutments each have an inclined cam surface 25A, 26A which engages that portion of the pin 11 projecting outwardly beyond the sides of the side plates 9. These cam surfaces 25A and 26A are arranged so that as the pin moves upwardly, the pin 11 is forced forwardly against the bias of the spring 12 attached also to the pin 11 so that the link 9A is pushed forwardly by the cam action thus moving the link forwardly again beyond the surfaces 14J and 14H into the position 9D with the end 9G of the link butting the surface 14F.

1. A crusher comprising:
a housing defining a bore into which one of more items to be crushed can be placed
the housing having an end plate defining an anvil against which the items are crushed;
a crusher head slidable within the bore in a crushing movement from a retracted position spaced from the anvil to a crushing position closely adjacent the anvil for crushing the items;
the housing defining an opening into the bore for insertion of the items to be crushed into the bore;
a manually operable lever having a manually graspable end portion movable in a crushing stroke relative to the housing for applying a force acting to move the crusher head along the bore;
the lever, the housing and the crusher head being arranged such that a first movement of the lever through the crushing stroke acts to move the crusher head through a first part of the crushing movement from the retracted position to an interim position spaced from the crushing position and such that a further movement of the lever through the crushing stroke acts to move the crusher head through a second part of the crushing movement to the crushing position.

2. The crusher according to claim 1 wherein the housing and the crusher head are arranged such that the second stroke moves the crusher head from the interim position to the crushing position so that only two strokes of the lever are required.

3. The crusher according to claim 1 wherein the lever is pivoted at a fixed position on the housing and the lever is movable relative to the crusher head between a first position in which movement of the lever through the crushing stroke acts to move the crusher head through the first part of the crushing movement and a further position in which movement of the lever through the crushing stroke acts to move the crusher head through the further part of the crushing movement.

4. The crusher according to claim 3 wherein there is provided a link connected from the lever to the crusher head such that pivotal movement of the lever on the housing acts to apply moving force to the crusher head through the link.

5. The crusher according to claim 4 wherein the link is slidable longitudinally along the crusher head to move the lever between the first and further positions.

6. The crusher according to claim 5 wherein the crusher head includes a first abutment surface against which the link abuts in the first position and a further abutment surface against which the link abuts in the further position.

7. The crusher according to claim 6 wherein the link is movable transversely of the crusher head from the first abutment surface to the further abutment surface.

8. The crusher according to claim 6 wherein the link includes an abutment member which engages an element on the housing arranged such that retraction of the link by the lever to a commencement end of the crushing stroke causes the link to be returned to the first position.

9. The crusher according to claim 1 wherein there is provided a spring acting to bias the crusher head to the retracted position

10. The crusher according to claim 1 wherein the lever, the housing and the crusher head are arranged such that a single reverse movement of the lever back through the crushing stroke to a commencement position acts to move the crusher head directly back to the retracted position.

11. The crusher according to claim 1 wherein there is provided a latch system arranged to locate the crusher head in the interim position and to prevent movement of the crusher head to the retracted position as the lever is moved back through the crushing stroke to a commencement position for the further stroke.

12. The crusher according to claim 11 wherein the latch system includes a first portion mounted on the crusher head and a second portion mounted in the housing so as to locate the crusher head in the interim position relative to the housing.

13. The crusher according to claim 12 wherein the first portion on the crusher head comprises a pivotal pawl and the second portion on the housing comprises an abutment guide arranged to move the pawl into a latching position in the interim position and to release the pawl from the latching position as the crusher head is returned to the retracted position.

14. The crusher according to claim 1 wherein there is provided a spring pulling the lever into the commencement position.

15. The crusher according to claim 1 wherein there is provided a locator ring on a crushing face of either the crusher head or the anvil for engaging around the mouth of a plastic bottle to locate the bottle between the crusher head and the anvil to avoid toppling during crushing.

16. The crusher according to claim 14 wherein the other of the crusher head and the anvil includes an array of protuberances on the crushing face thereof.

17. The crusher according to claim 1 wherein the housing includes a front face with a slot in the front face through which the lever projects for movement longitudinally of the front face and wherein the opening is provided in the front face.

18. The crusher according to claim 1 wherein the end plate defining the anvil is mounted in a slot in the housing allowing the end plate to be removable by sliding across the bore to allow crushed materials to escape from the end of the bore.
